(19) United States
(12) Patent Application Publication
(10) Pub. No.: US 2011/0134346 A1
(43) Pub. Date: Jun. 9, 2011

(54) DISPLAY DEVICE AND TELEVISION RECEIVER

(75) Inventors: Keiji Hayashi, Osaka-shi (JP); Toshihide Tsubata, Osaka-shi (JP)

(73) Assignee: SHARP KABUSHIKI KAISHA, Osaka-shi, Osaka (JP)

(21) Appl. No.: 13/057,787

(22) PCT Filed: Jun. 11, 2009
(86) PCT No.: PCT/JP2009/060666

§ 371 Date: Feb. 7, 2011

(30) Foreign Application Priority Data
Aug. 22, 2008 (JP) 2008-214340

(51) Int. Cl. G02F 1/1333; H04N 3/14

(52) U.S. Cl. 348/790; 349/58; 348/E03.016

(57) ABSTRACT

A liquid crystal display device 10 includes a liquid crystal display module 11 and a pair of exterior members 13, 14. The liquid crystal display module 11 includes a liquid crystal panel 15 and LEDs 21b. The liquid crystal panel 15 is configured to display images and the LEDs 21b are arranged on a surface that is substantially perpendicular to a display surface 15a of the liquid crystal panel 15. The exterior members 13, 14 house the liquid crystal display module 11 therein and one of the exterior members 13, 14 is provided close to the display surface 15a and another one of the exterior members 13, 14 is provided far from the display surface 15a, and the exterior members 13, 14 are connected to each other. The exterior members 13, 14 include side walls 13b, 13c, 14b, 14c that form a connecting part of the exterior members 13, 14. A hole 26 is formed in long-side side walls 13b, 14b so as to penetrate therethrough. An opening edge 27 of the hole 26 is shared by the exterior members 13, 14. Accordingly, various designs of the hole are enabled.

### TECHNICAL FIELD

The present invention relates to a display device and a television receiver.

### BACKGROUND ART

In recent years, flat display devices using a flat display element such as a liquid crystal panel and a plasma display panel have been used widely in image display devices such as television receivers compared with conventional Braun tubes. This enables an image display device to be thinner.

A liquid crystal panel included in a liquid crystal display device does not emit light, and thus a backlight device is required as a separate lighting device. The backlight device is arranged behind the liquid crystal panel (i.e., on a side opposite from a display surface side). It includes a metal chassis having an opening on a liquid crystal panel side and a light source accommodated in the chassis.

An edge-light type backlight device has been known for making the backlight device thinner. In the edge-light type backlight device, light sources are arranged on peripheral parts of the chassis. Light emitting from the light sources enters light guide plate to convert the light into planer light and the planer light is directed to the liquid crystal panel. In such a thin backlight device, a space in the device is small and closed. This makes difficult to release heat generated at the light sources to outside of the device. Therefore, in such a thin backlight device, the temperature is easy to increase in the surroundings of the light sources and this easily lowers luminance efficiency and causes thermal deterioration of the light sources.

To solve such problems, Patent Document 1 discloses that a front frame and a rear cover that are assembled together to house a liquid crystal panel and a backlight device therein and the front frame and a housing hold the liquid crystal panel therebetween. An opening is formed on a part of the housing facing the light source and an aperture is formed on the front frame so as to be continuous to the opening. Heat generated at the light source is released to outside of the device via the opening and the aperture.

[Patent Document 1] Japanese Unexamined Patent Publication No. 2002-279819

### Problem to be Solved by the Invention

However, in the configuration disclosed in Patent Document 1, the aperture is formed only on the front frame and the front frame is configured to have an entire opening edge of the aperture. Therefore, following problems may be caused. The opening edge of the aperture is formed in a ring and the entire ring opening edge is included in the front frame. This increases restrictions on designing the aperture shape due to an issue of molding. Problems occur when the aperture shape is required to be complicated in response to a request for improving safety and heat releasing property, for example.

### DISCLOSURE OF THE PRESENT INVENTION

The present invention was made in view of the foregoing circumstances. An object of the present invention is to achieve various designs of a hole.

### Means for Solving the Problem

To solve the above problem, a display device of the present invention includes a display module including a display element and a light source, a pair of exterior members and the opening edge. The display element is configured to display images and the light source is arranged on a surface that is substantially perpendicular to a display surface of the display element. The exterior members are configured to house the display module therein and one of the exterior members is provided close to the display surface and another one of the exterior members is provided away from the display surface, and the exterior members are connected to each other. The opening edge is configured to form an opening edge of a hole that runs all the way through the connected exterior members from inside to outside around the connecting area. The hole has the opening edge formed by edges of the exterior members.

Accordingly, air flows in and out of the exterior members via the opening. This preferably releases heat generated at the light source when it is lit on. The hole edge of the opening is shared by the exterior members. Therefore, compared to a case that one of the exterior members has an entire opening edge, the hole and the exterior members are freely designed.

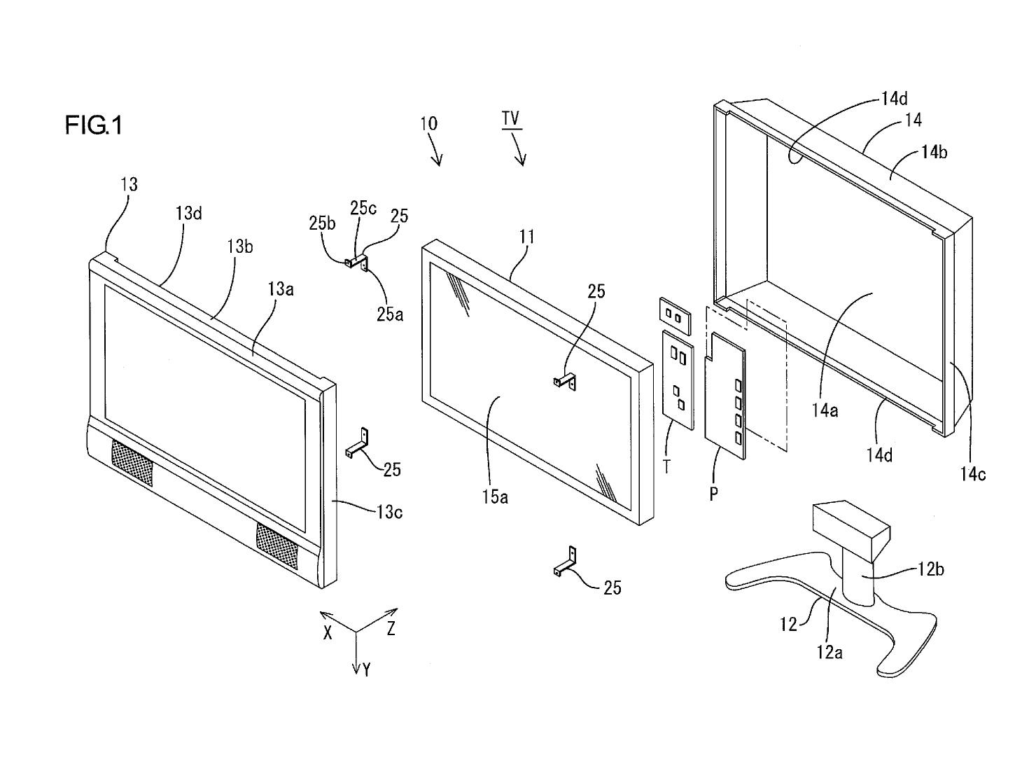

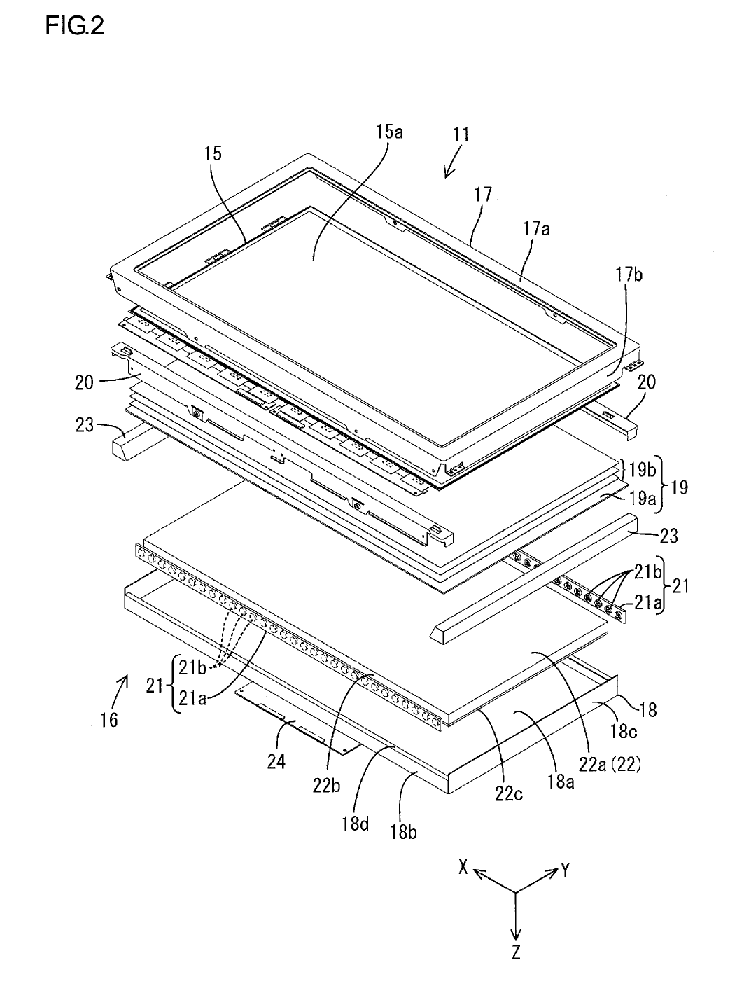

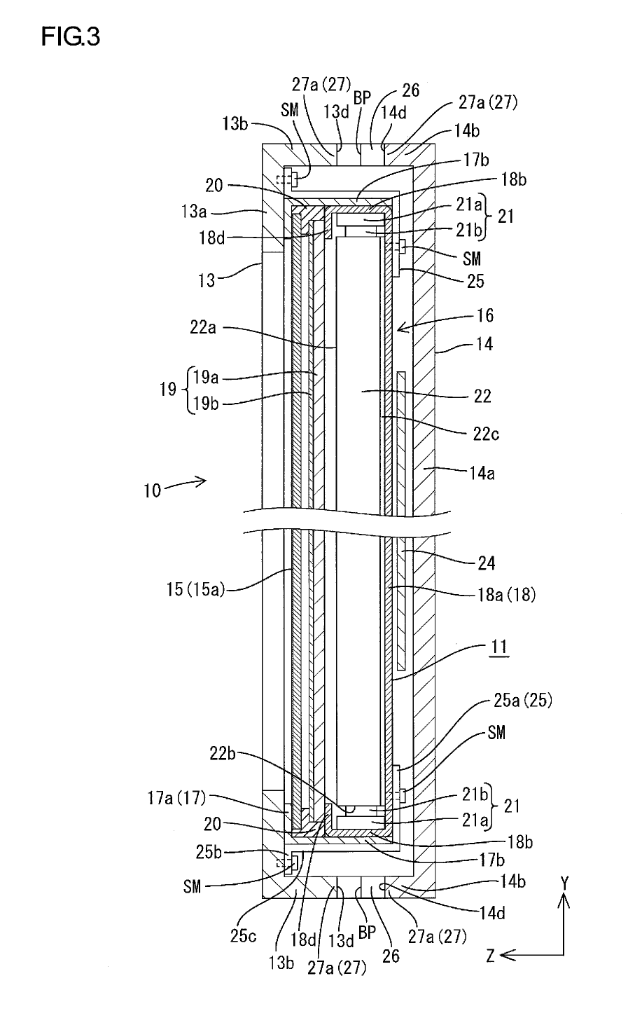

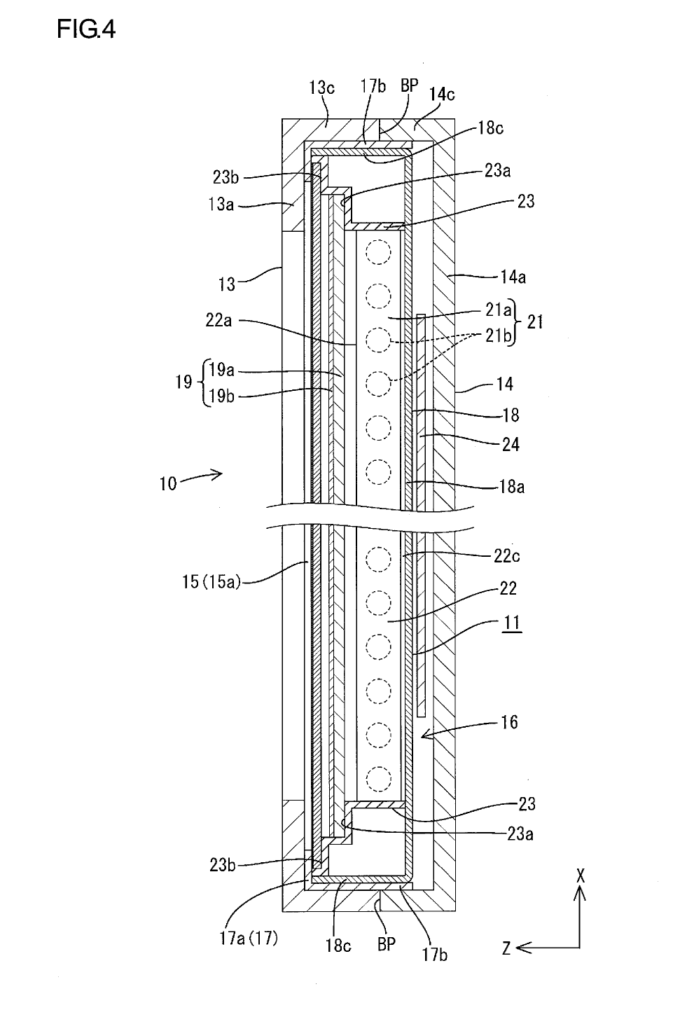

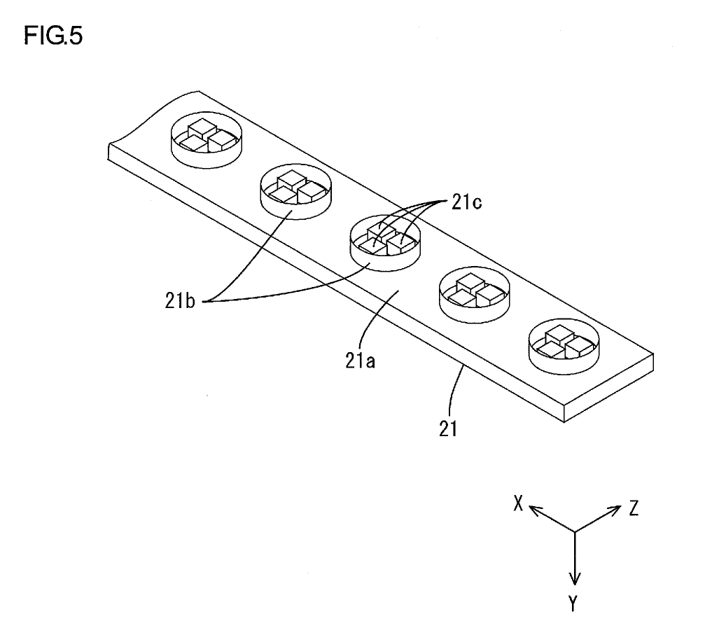

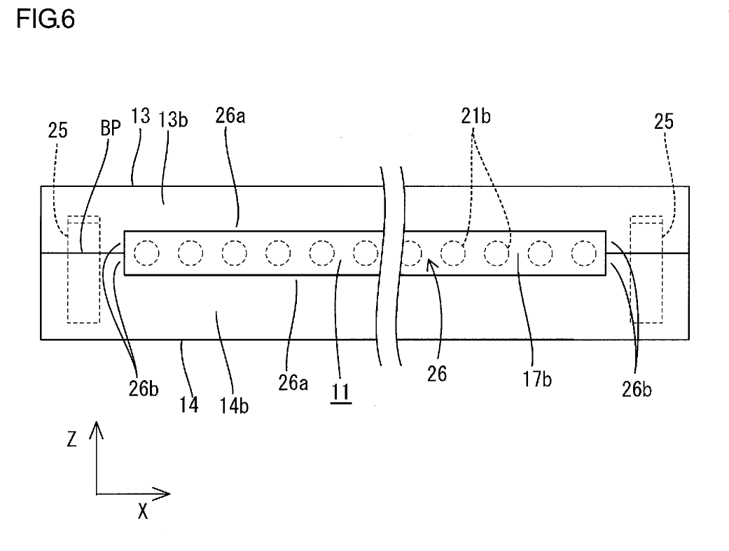

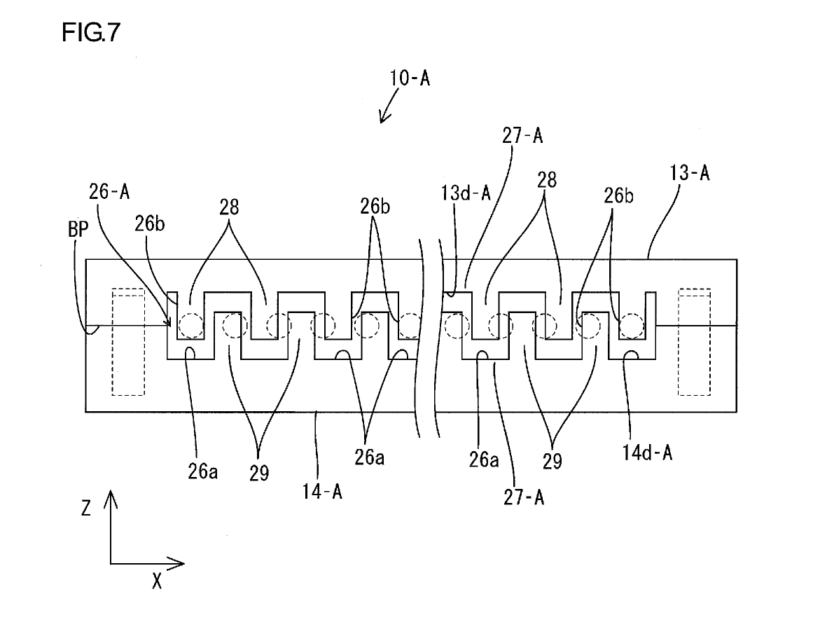

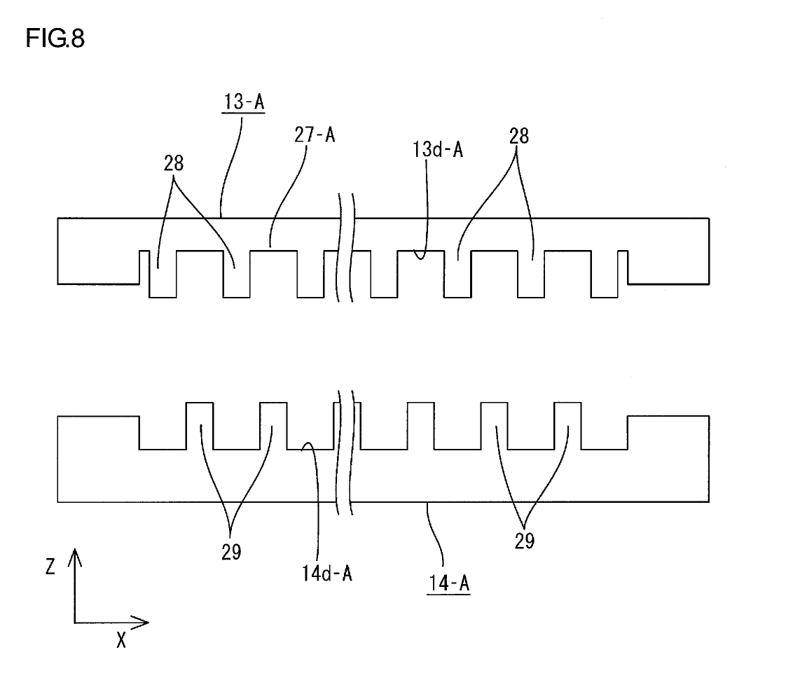

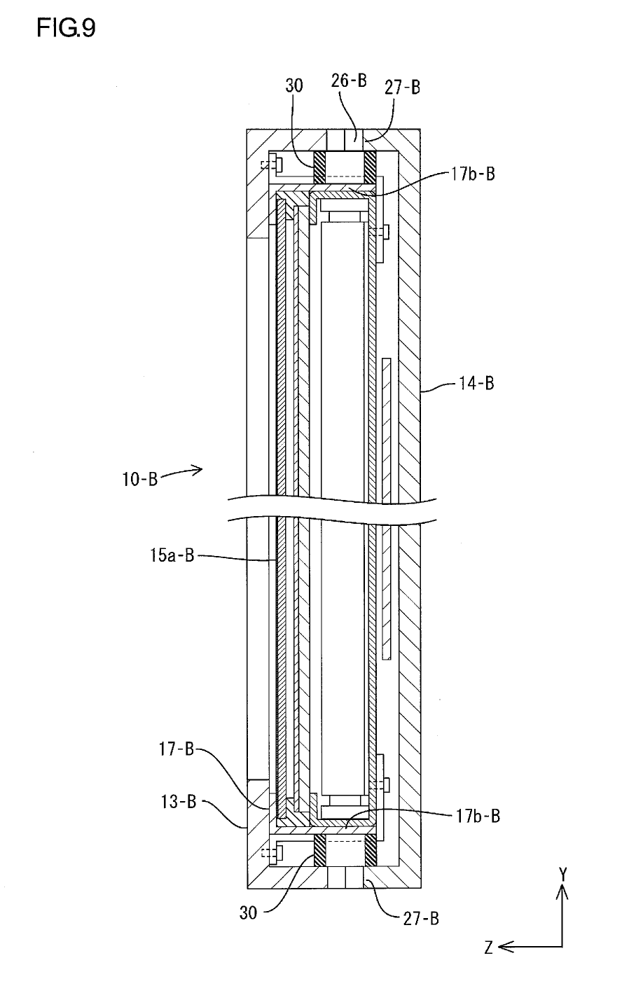

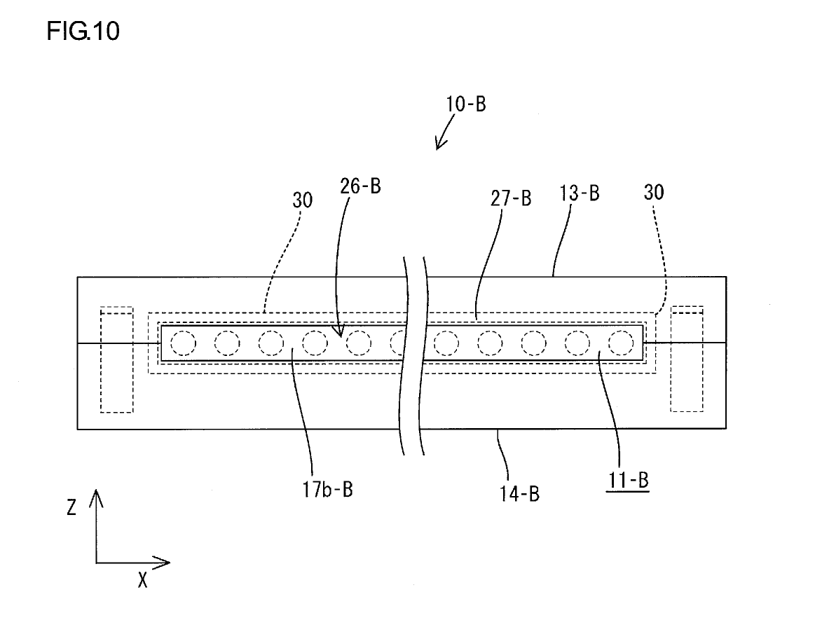

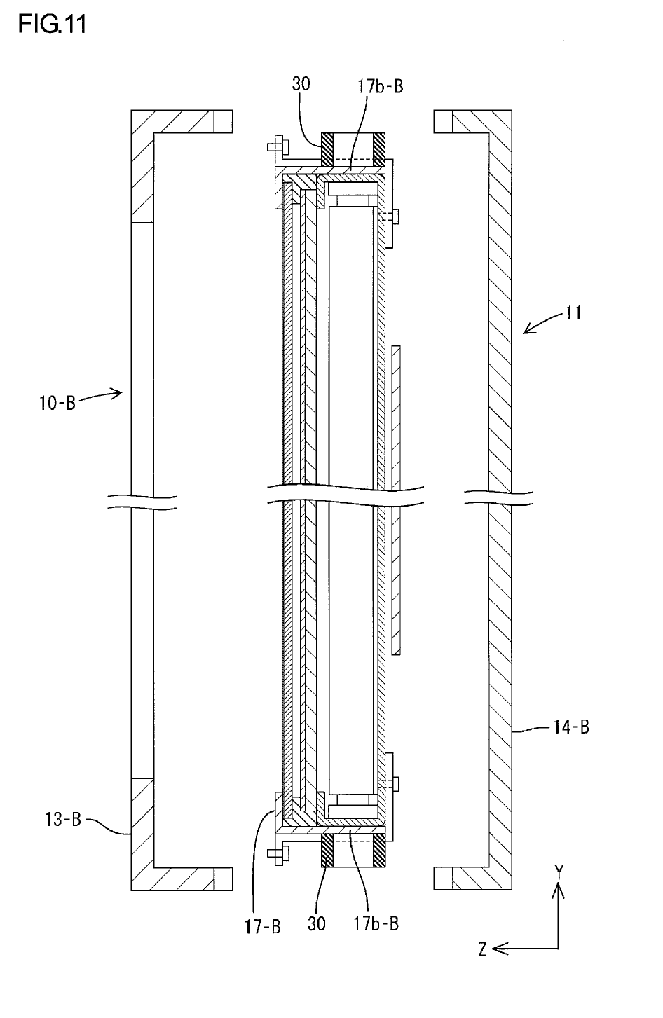

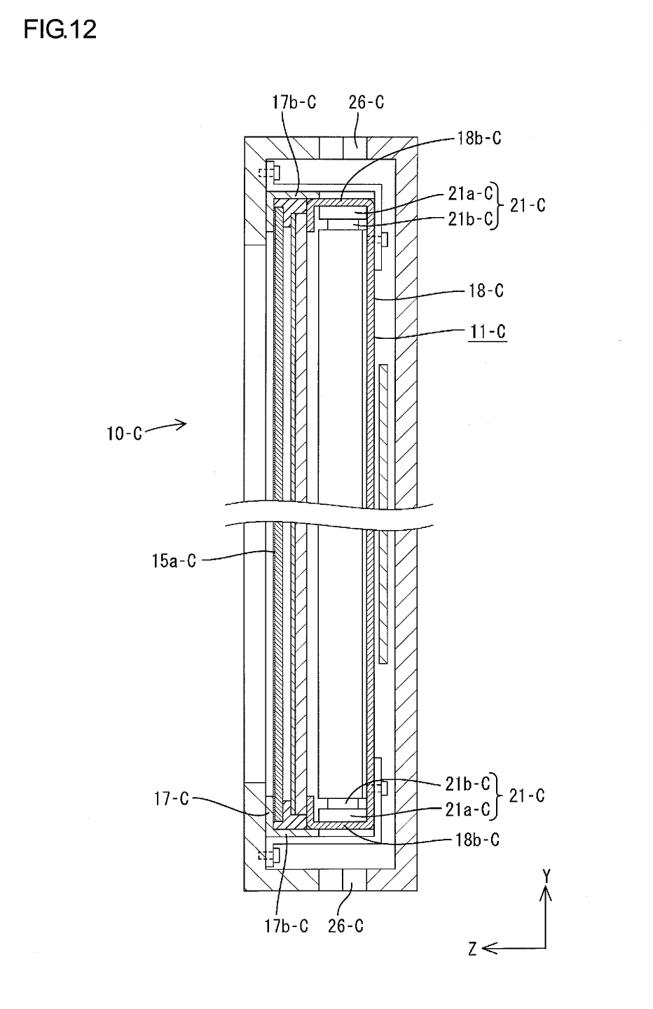

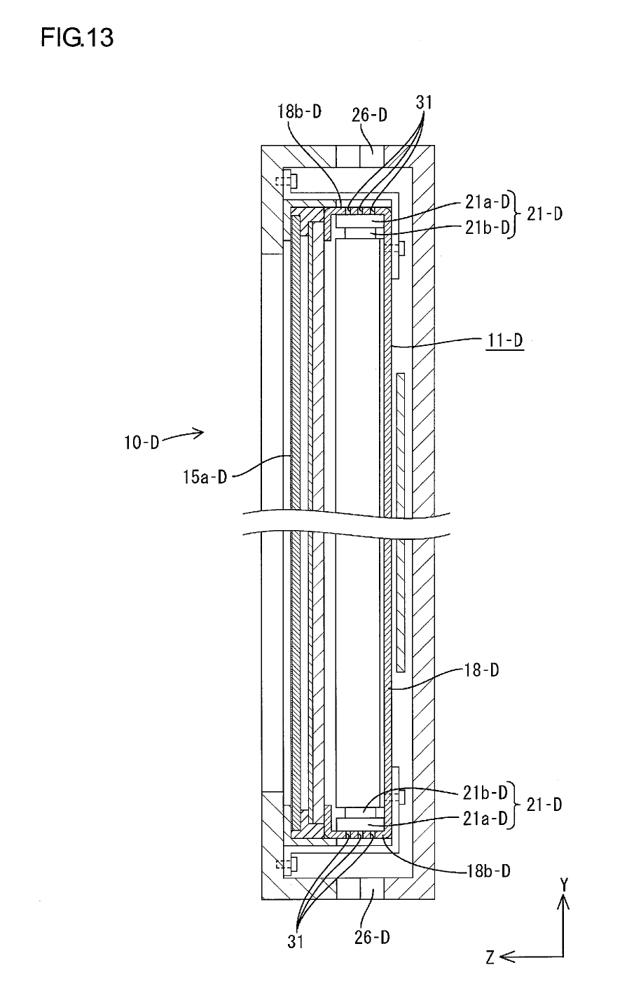

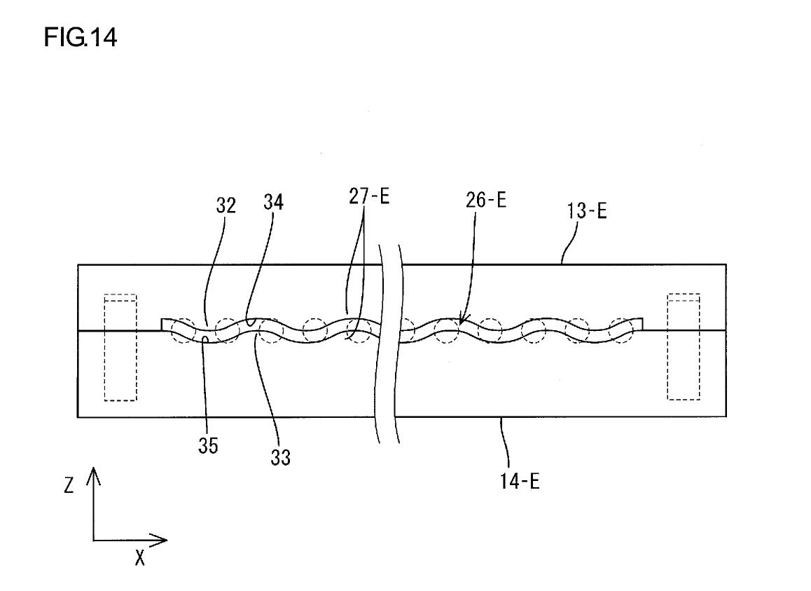

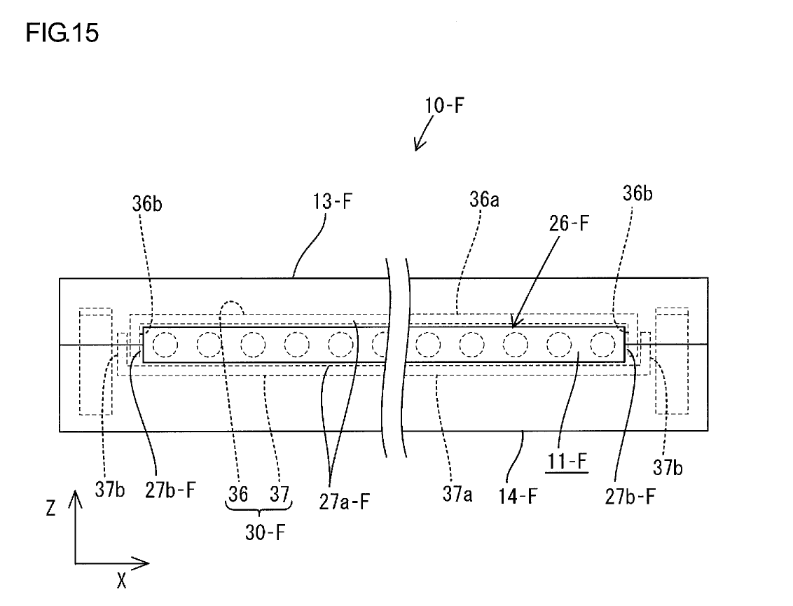

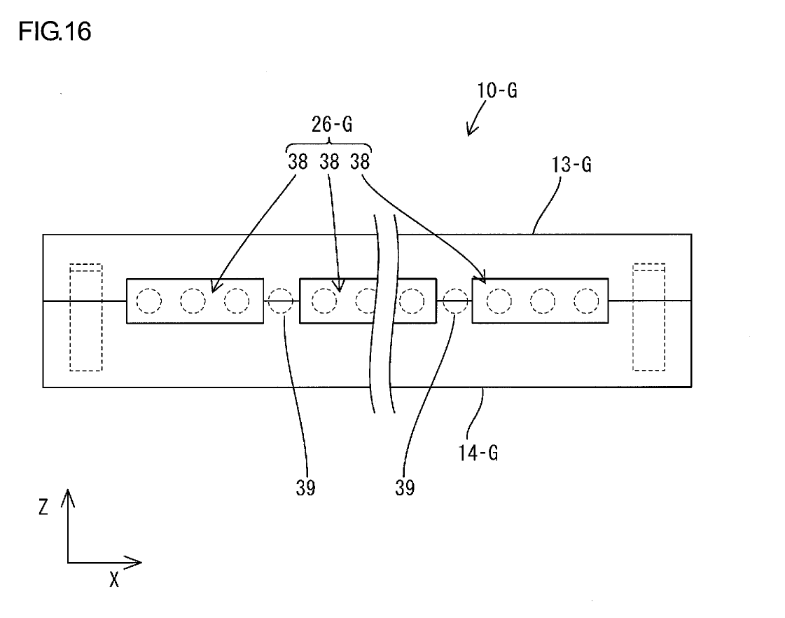

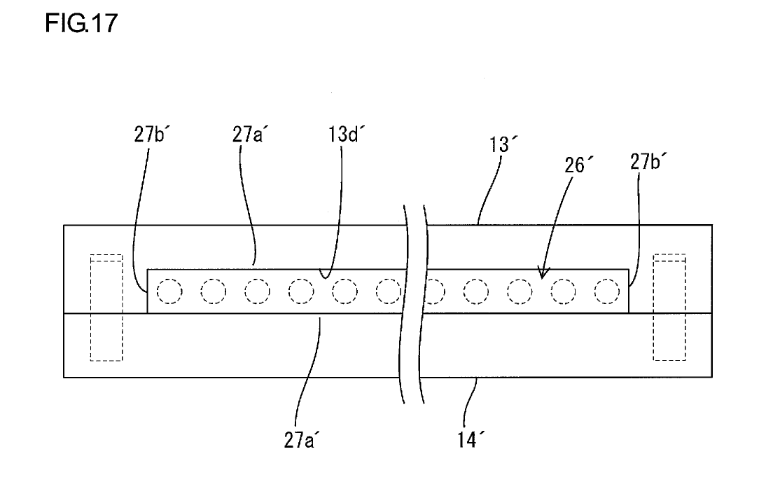

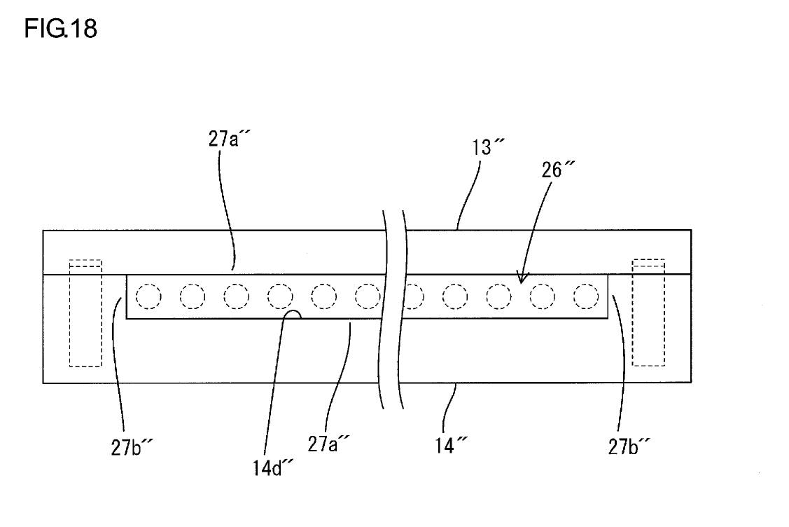

### BRIEF DESCRIPTION OF THE DRAWINGS

[FIG. 1] is an exploded perspective view illustrating a general construction of a television receiver according to a first embodiment of the present invention;

[FIG. 2] is an exploded perspective view illustrating a general construction of a liquid crystal display device provided in the television receiver;

[FIG. 3] is a cross-sectional view of the liquid crystal display device along the short-side direction;

[FIG. 4] is a cross-sectional view of the liquid crystal display device along the long-side direction;

[FIG. 5] is a perspective view illustrating a general construction of an LED unit;

[FIG. 6] is a plan view illustrating the liquid crystal display device;

[FIG. 7] is a plan view illustrating a liquid crystal display device of a second embodiment of the present invention;

[FIG. 8] is a plan view illustrating exterior members before being assembled together;

[FIG. 9] is a cross-sectional view of a liquid crystal display device along the short-side direction;

[FIG. 10] is a plan view illustrating the liquid crystal display device;

[FIG. 11] is a cross-sectional view illustrating the exterior members before being assembled to a liquid crystal display module;

[FIG. 12] is a cross-sectional view of a liquid crystal display device according to a fourth embodiment of the present invention along the short-side direction;

[FIG. 13] is a cross-sectional view of a liquid crystal display device according to a fifth embodiment of the present invention along the short-side direction;

[FIG. 14] is a plan view illustrating a liquid crystal display device according to a sixth embodiment of the present invention;

[FIG. 15] is a liquid crystal display device according to a seventh embodiment of the present invention;

[FIG. 16] is a liquid crystal display device according to an eighth embodiment of the present invention;

[FIG. 17] is a liquid crystal display device according to another embodiment (2) of the present invention; and

[FIG. 18] is a liquid crystal display device according to another additional embodiment (3) of the present invention.

### BEST MODE FOR CARRYING OUT THE INVENTION

### First Embodiment

The first embodiment of the present invention will be explained with reference to FIGS. 1 to 6. In the present embodiment, a liquid crystal display device 10 including a built-in liquid crystal display module 11 will be explained. An X-axis and a Y-axis are illustrated in each drawing and each axial direction represents a direction illustrated in each drawing. The X-axis direction represents a horizontal direction and the Y-axis direction represents a vertical direction. A left side in FIGS. 3 and 4 (an upper side in FIG. 2) is referred to as a front side and a right side in FIGS. 3 and 4 (a lower side in FIG. 2) is referred to as a rear side.

The liquid crystal display device 10 of the present embodiment includes a liquid crystal display module 11, a stand (support member) and a pair of exterior members 13, 14 as illustrated in FIG. 1. The stand 12 supports the liquid crystal display module 11 so that a display surface 15a is parallel to the vertical direction (Y-axis direction). The exterior members 13, 14 house the liquid crystal display module 11 therein. A power source P and a tuner T are housed and arranged in the exterior members 13, 14 of the liquid crystal display device 10 to configure a television receiver TV that receives television signals and display television images.

An overall shape of the liquid crystal display module 11 is a landscape rectangular. As illustrated in FIG. 2, it includes a liquid crystal panel 15 as a display panel (display element), and a backlight device 16 (lighting device), which is an external light source. They are integrally held by a bezel 17 and the like.

The liquid crystal panel 15 is formed in a rectangular shape with plan view so that the display surface 15a is parallel to the horizontal direction (X-axis direction) and the vertical direction (Y-axis direction). The long-side direction is parallel to the horizontal direction and the short-side direction is parallel to the vertical direction. The liquid crystal panel 15 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, counter electrodes, a color filter having color sections such as R (red), G (green) and B (blue) color sections arranged in a predetermined pattern, and an alignment film are provided. Image data and various control signals necessary to display images are supplied from a driving circuit board (not shown) to the source lines, the gate lines and counter electrodes. Polarizing plates (not shown) are attached to outer surfaces of the substrates.

The backlight device 16 includes a chassis 18, an optical member 19, and frames 20. The chassis 18 has a substantially box-shape and an opening on the front side (the display surface 15a, the light output side, the liquid crystal panel 15 side). The optical member 19 is provided to cover the opening of the chassis 18. The frames 20 arranged along the long sides of the chassis 18 hold the long-side edges of the optical member 19 to the chassis 18. The long-side edges of the optical member 19 are sandwiched between the chassis 18 and the frames 20. A pair of LED units 21, a light guide plate 22 and a pair of holders 23 are provided in the chassis 18. Each of the LED units 21 is provided on each of the long-side outer rim of the chassis 18 and emits light. The light guide plate 22 is provided between the LED units 21 and guides light emitted from the LED units 21 to the liquid crystal panel 15. Each of the holders 23 is provided on the short-side outer rim of the chassis 18. The edges of the optical member 19 and the liquid crystal panel 15 are placed on the holders 23. In a so-called edge-light type (side-light type) backlight device 16 of this embodiment, the light source is provided at the side of the chassis 18.

The chassis 18 is made of metal that is excellent in heat conductivity such as an aluminum material. It includes a rectangular bottom plate 18a and side plates 18b, 18c each of which extends upright from the corresponding outer periphery end of the bottom plate 18a. The bottom plate 18a is configured such that the long-side direction is parallel to the horizontal direction (X-axis direction) and the short-side direction is parallel to the vertical direction (Y-axis direction). As illustrated in FIG. 3, an extending plate 18d extends inwardly (so as to get close to the light guide plate 22) from each of the long-side side plates 18b lifting up from the long-side outer ends (upper and lower outer ends in the vertical direction) of the bottom plate 18a. The long-side outer rims of the chassis 18 are folded and this ensures a housing space that houses the LED units 21 therein. The light guide plate 22 is housed in a space between the housing spaces of the LED units 21 in the chassis 18. The long-side ends of the optical member 19 are placed on the front surfaces of the extending plates 18d respectively. The long-side side plates 18b and the short-side side plates 18c form an overall shape of a substantially square tube (FIG. 2). A power source circuit board 24 that supplies electric power to the LED units 21 is arranged on the rear surface of the bottom plate 18a. In the present embodiment, the chassis 18 is made of an aluminum material to ensure high heat conductivity. However, it may be made of metal, for example, if requiring greater rigidity.

The optical member 19 is formed in a rectangular shape like the liquid crystal panel 15 and the bottom plate 18a of the chassis 18 as illustrated in FIG. 2. The optical member 19 includes a diffuser plate 19a and optical sheets 19b provided on the front side of the diffuser plate 19a. The diffuser plate 19a includes a synthetic resin plate containing scattered light diffusing particles. It diffuses light emitted from the LED units 21 and guided by the light guide plate 22. The optical sheets 19b include a diffuser sheet, a lens sheet and a reflecting type polarizing plate layered in this order from the diffuser plate 19a side. Light emitted from the LED units 21 passes through the diffuser plate 19a and enters the optical sheets 19b. The optical sheets 19b convert the light emitting from the LED units 21 and passing through the diffuser plate 19a to planar light.

The frames 20 are made of metal that is excellent in heat conductivity such as an aluminum material. Each frame 20 extends along the long-side direction of the chassis 18 and is provided on the surface of each long-side sideplate 18b and each extending plate 18d of the chassis 18. The long-side edges of the optical member 19 are held between the frames 20 and the extending plates 18d. The frames 20 receive the rear sides of the long-side edges of the liquid crystal panel 15. Iron, for example, may be used for a material of the frames 20 if high rigidity is required.

Each LED unit 21 includes a wiring board 21a and a plurality of LEDs 21b (light emitting diode) that are mounted on the wiring board 21a. The wiring board 21a is configured by forming wiring patterns on a surface of a metal substrate having an insulation layer therebetween. The metal substrate is made of metal having excellent heat conductivity such as an aluminum material. The wiring pattern is made of a metal film such as a copper foil. The wiring board 21a is formed in an elongated plate extending along the X-axis direction that is the long side of the chassis 18. Each LED 21b includes three LED chips 21c fixed thereto by resin, as illustrated in FIG. 5. Each of the three LED chips 21c emits light of a single color of R (red), G (green) and B (blue). The LEDs 21b are arranged along a longitudinal direction (X-axis direction) on the surface of the wiring board 21a, as illustrated in FIGS. 2 and 4. The LEDs 21b are arranged on a surface that is substantially perpendicular to the display surface 15a of the liquid crystal panel 15 (a surface parallel to the X-axis direction and the Z-axis direction). The LED units 21 are fixed to the chassis 18 with contacting an inner surface of each long-side side plate 18b by a screw, for example, so that the LEDs 21b are opposed to each other. Iron may be used as the material of the substrate of the wiring board 21a in addition to the aluminum material.

The light guide plate 22 is formed in a rectangular plate like the optical member 19, as illustrated in FIG. 2, and made of resin having high translucency (high transparency) such as acrylic. The light guide plate 22 is disposed between the opposing LED units 21 so that its main surface faces the diffuser plate 19a. The side surfaces 22b along the X-axis direction (upper and lower side surfaces 22b in the vertical direction) among the outer side surfaces of the light guide plate 22 are provided so as to be opposed to the LED units 21 respectively, and the side surfaces 22b are entrance planes which light emitted from the LED units 21 enters. The main plate surface 22a of the light guide plate 22 facing the diffuser plate 19a is an exit plane from which the light entering the light guide plate 22 from the entrance planes exits. A light reflecting sheet 22c is disposed on a surface of the light guide plate 22 opposite from the surface facing the diffuser plate 19a (a surface facing the bottom plate 18a of the chassis 18). The light reflecting sheet 22c reflects the light penetrating through the light guide plate 22 to return the light into the light guide plate 22. The light guide plate 22 makes the light emitting from the LED units 21 and entering the side surfaces 22b of the light guide plate 22 to be output from the main surface 22a of the light guide plate 18 facing the diffuser plate 19a. Accordingly, the light is irradiated to the liquid crystal panel 15 from its rear side.

The holders 23 are made of white synthetic resin. As illustrated in FIGS. 2 and 4, the holders 23 are formed in an elongated substantially box shape extending along the short-side side plates 18c of the chassis 18 and fixed to the chassis 18 so as to be arranged along the short-side side plates 18c of the chassis 18. Each holder 23 has steps 23a, 23b on which the diffuser plate 19a and the liquid crystal panel 15 placed at different levels. The holders 23 receive rear sides of the short-side edges of the diffuser plate 19a and the liquid crystal panel 15.

The bezel 17 is formed of metal that is excellent in heat conductivity such as an aluminum material. As illustrated in FIGS. 2 to 4, the bezel 17 includes a frame plate 17a and side plates 17b. The frame late 17a presses the outer peripheral portions of the liquid crystal panel 15 from the front side (display surface 15a side). The side plates 17b extend from the outer peripheral ends of the frame plate 17a toward the rear side. The frame plate 17a is formed to surround a display area (active area) that is a middle portion of a display of the liquid crystal panel 15 and is in contact with the outer peripheral portions of the liquid crystal panel 15 that are non-display areas (non-active areas). The frame plate 17a and the frames 20 hold the long-side end portions of the liquid crystal panel 15 therebetween and the frame plate 17a and the holders 23 hold the short-side end portions of the liquid crystal panel 15 therebetween. The side plates 17b are formed in a substantially square tube that is slightly greater than the chassis 18 as a whole and is fitted to the side plates 18b, 18c of the chassis 18 from the front side. The inner surfaces of the side plates 17b come in contact with the outer surfaces of the side plates 18b, 18c of the chassis 18 and the frames 20 over substantially an entire area. Therefore, with respect to the wiring board 21a of the LED unit 21, the long-side side plates 18b of the chassis 18 are laminated on the corresponding side plates 17b of the bezel in this order from the inner side in the Y-axis direction (vertical direction). Iron may be used as a material of the bezel 17 if further high rigidity is required.

The stand 12 includes, as illustrated in FIG. 1, a base 12a and a shaft 12b. The base 12a is directly placed on an installation surface of the liquid crystal display device 10 and the shaft 12b extends vertically and upwardly from the base 12a. The shaft 12b is mounted to the rear side of the chassis 18 that forms the liquid crystal display module 11. The stand 12 supports the liquid crystal display module 11 so that the display surface 15a is positioned along the Y-axis direction (the vertical direction). In such a state, the LED units 21 are placed on the upper and lower end sides of the liquid crystal display module 11 in the vertical direction (FIG. 3). The stand 12 is not shown in FIGS. 3 and 4.

In the present embodiment, the display surface 15a of the liquid crystal display module 11 is placed along the vertical direction. This is not limited to the case that the display surface 15a of the liquid crystal display module 11 is placed to be parallel to the vertical direction. This also includes the case that the display surface 15a is placed relatively along the vertical direction compared to the case that it is placed along the horizontal direction. For example, the display surface 15a may lean at 0 to 45 degrees, preferably 0 to 30 degrees with respect to the vertical direction.

The exterior members 13, 14 that house the above-configured liquid crystal display module 11 are made of synthetic resin. As illustrated in FIG. 1, the exterior members 13, 14 include a first exterior member 13 and a second exterior member 14. The first exterior member 13 is provided at the front side (the display surface 15a side) of the liquid crystal display module 11 and the second exterior member 14 is provided on the rear side (an opposite side from the display surface 15a side). In other words, the liquid crystal display module 11 is fitted in a space formed between a pair of exterior member 13, 14 that is divided into two parts along the display surface 15a at a predetermined position in the thickness direction (Z-axis direction).

The front-side first exterior member 14 includes frame walls 13a and side walls 13b, 13c. The frame walls 13a press the bezel 17 from the front side and the side walls 13b, 13c extend rearward from the outer peripheral ends of the frame walls 13a. The frame walls 13a form like a picture frame along the frame plate 17a of the bezel 17. The rear surfaces of the frame walls 13a come in contact with substantially an entire area of the front-side surface of the frame plate 17a of the bezel 17. The side walls 13b, 13c form substantially a square tube that is greater than the side plates 17b of the bezel 17 and is fitted to the side plates 17b from the front side. The long-side side walls 13b are provided to be opposed to the corresponding side plates 17b of the bezel 17 with a predetermined space (being separated) therebetween as illustrated in FIG. 3. The short-side side walls 13c are in contact with the corresponding side plates 17b of the bezel 17 as illustrated in FIG. 4.

The rear-side second exterior member 14 includes, as illustrated in FIGS. 3 and 4, a main wall 14a and side walls 14b, 14c and is formed in substantially a shallow dish as a whole. The main wall 14a is provided at the rear side of the chassis 18 of the liquid crystal display module 11. The side walls 14b, 14c extend frontward from the corresponding outer peripheral ends of the main wall 14a. The main wall 14a is formed in a rectangular shape like the bottom plate 18a of the chassis 18 and is provided to be opposed to the bottom plate 18a with a predetermined distance therebetween (being separated therefrom). The side walls 14b, 14c form substantially a square tube that is substantially same size as the one formed by the side walls 13b, 13c of the first exterior member 13. The side walls 14b, 14c are fitted to the side plates 17b of the bezel 17 from the rear side. The long-side side walls 14b are provided to be opposed to the side plates 17b of the bezel 17 with a predetermined space therebetween (being separated) as illustrated in FIG. 3. The short-side side walls 14c are in contact with the side plates 17b of the bezel 17 as illustrated in FIG. 4. The second exterior member 14 has a stand insertion opening (not shown) in which the shaft 12b of the stand 12 is inserted.

When the exterior members 13, 14 are assembled to each other, as illustrated in FIGS. 3 and 4, the side walls 13b, 13c, 14b, 14c are connected to each other with the distal ends in the assembling direction (Z-axis direction) being in contact with each other. In other words, the side walls 13b, 13c, 14b, 14c form connecting part of the exterior members 13, 14. The connecting part BP of the side walls 13b, 13c, 14b, 14c in the assembling direction lies on a same plane with a substantially middle part of the LED unit 21 of the liquid crystal display module 11 with respect to the Z-axis direction.

The first exterior member 13 is fixed to the liquid crystal display module 11 by a fixing member 25 (bracket) as illustrated in FIGS. 1 and 3. The fixing member 25 is formed in substantially a crank by bending a metal plate. Four fixing members 25 are provided at each corner of the outer peripheral ends of the first exterior member 13 and the liquid crystal display module 11. Each fixing member 25 includes a first plate portion 25a, a second plate portion 25b and a third plate portion 25c. The first plate portion 25a is provided on the rear side of the bottom plate 18a of the chassis 18. The second plate portion 25b is provided on the rear side of the frame wall 13a of the first exterior member 13. The third plate portion 25c connects the first plate portion 25a and the second plate portion 25b and extends along the Z-axis direction. The first plate portion 25a is fixed to the rear surface of the bottom plate 18a of the chassis by a screw SM so that a corner of the liquid crystal display module 11 is fitted to a corner of the fixing member 25. The portion of the bottom plate 18a of the chassis 18 with which the first plate portion 25a is in contact corresponds to the portion of the liquid crystal display module 11 in which the LED unit 21 is arranged. The second plate portion 25b is fixed to the rear surface of the frame wall 13a of the first exterior member 13 by the screw SM so that a corner of the fixing member 25 is fitted to a corner made by the first exterior member 13 and the liquid crystal display module 11. The third plate portion 25c is in contact with the outer surface of the side plate 17b of the bezel 17 over substantially an entire length of the third plate portion 25c. The second exterior member 14 is directly fixed to the first exterior member 13 by a fixing member (not shown) or fixed to the chassis 18 by a fixing member (not shown) to be fixed indirectly to the first exterior member 13.

As illustrated in FIGS. 1 and 3, a hole 26 is provided in the side walls 13b, 13c, 14b, 14c that form the connecting part of the exterior members 13, 14. Air flows in and out of the exterior members 13, 14 via the holes 26. This releases heat generated at the LED units 21 to outside.

The holes 26 are formed in the long-side side walls 13b, 14b among the side walls 13b, 13c, 14b, 14c as illustrated in FIGS. 3 and 6. Each hole 26 is formed to extend along the X-axis direction that is a longitudinal direction of each long-side side wall 13b, 14b (the long-side direction of the liquid crystal display module 11, X-axis direction) and is substantially an elongated rectangular opening. A length of the hole 26 is approximately same as a length of the LED unit 21. An opening edge 27 of the hole 26 is formed in substantially an elongated frame with plan view and in an endless loop. The hole 26 is formed in both of the long-side side walls 13b, 14b so that a part of the hole 26 is formed at the first exterior member 13 side from the contacting end surfaces of the long-side side plates 13b, 14b (the connecting part BP) and the rest part of the hole 26 is formed at the second exterior member 14 side from the connecting part BP. Accordingly, the opening edge 27 forming the hole 26 is formed in the first and second exterior members 13, 14. In other words, each of the exterior members 13, 14 has a part of the opening edge 27 of the hole 26.

Specifically, the hole 26 is formed by forming recesses 13d, 14d at the end surfaces of the long-side side walls 13b, 14b of the exterior members 13, 14. The recesses 13d, 14d are formed to penetrate through the exterior members 13, 14 in the vertical direction (Y-axis direction) and open in the assembling direction of the exterior members 13, 14 (Z-axis direction). A depth (in the Z-axis direction) of each recess 13d, 14d at the end of each long-side side wall 13b, 14b is substantially equal to each other. In other words, the first exterior member 13 and the second exterior member 14 form the opening edge 27 of the hole 26 half-and-half. Each of the edges of the first exterior member 13 and the second exterior member 14, which are parts of the opening edge 27, is formed in substantially a channel like shape with plan view. The opening edge 27 of the first exterior member 13 is connected to the opening edge 27 of the second exterior member 14 to form a continuous opening edge 27 that is formed in an endless loop. On the opening edge 27, an entire long-side opening edge 27a along the X-axis direction is provided on the first exterior member 13 and the second exterior member 14 respectively. However, the first and second exterior members 13, 14 share each of the short-side opening edges 27b along the Z-axis direction half-and-half. A width (in the Z-axis direction) of the hole 26 is set so that a user's finger is not inserted therein. For example, the width of the hole 26 is set to several millimeters.

As described above, as illustrated in FIG. 3, the hole 26 is formed in the long side-side walls 13b, 14b, that is, the hole 26 is formed at the upper and lower side walls 13b, 14b in the vertical direction. Therefore, the hole 26 opens upwardly and downwardly and penetrates vertically through the side walls 13b, 14b. Therefore, if air convection is caused in a space formed by the exterior members 13, 14 by the heat generated at the LEDs 21b, external air flows into the space formed by the exterior members 13, 14 from the lower hole 26 and inner air flows out of the upper hole 26 by the convection. This circulation is accelerated by the air convection. The hole 26 is provided so as to overlap with the LED unit 21 in the vertical direction (Y-axis direction) that is along the display surface 15a. The width (in Z-axis direction) of the hole 26 is substantially equal to the width of the LED unit 21. The hole 26 is provided to correspond to the LED unit 21 with respect to the Z-axis direction. When the liquid crystal display device 10 is seen from the vertical direction, as illustrated in FIG. 6, the LEDs 21b are arranged along a line of the connecting part BP of the exterior members 13, 14 that is substantially a center portion in the hole 26 in its width direction (Z-axis direction). The hole 26 is formed so as not to overlap with the fixing members 25 in the vertical direction.

The side plate 17b of the bezel 17 in the liquid crystal display module 11 is provided to correspond to the hole 26 as illustrated in FIG. 3. The side plate 17b of the bezel 17 is directly exposed to the external air introduced form the hole 26. The side plates 18b, 18c are in contact with the side plates 17b of the bezel 17 and the wiring board 21a of the LED unit 21 is in contact with each side plate 18b, 18c. That is, the wiring boards 21a of the LED units 21 are thermally connected to the side plates 17b of the bezel 17 via the side plates 18b, 18c of the chassis 18. The side plates 17b are exposed to outside via the hole 26. The bezel 17, the chassis 18 and the wiring boards 21a of the LED units 21 that are thermally connected to each other are made of metal such as an aluminum material that is excellent in heat conductivity. Therefore, heat generated at the LEDs 21b is efficiently transferred to the external air introduced from the hole 26.

The thus configured liquid crystal display device 10 is positioned and supported so that the display surface 15a is parallel to the vertical direction by the stand 12 when it is in use. If the power of the liquid crystal display device 10 is turned on, each LED 21b of the LED unit 21 is lit and image signals are supplied to the liquid crystal panel 15. The light emitted from each LED 21b and directed in the Y-axis direction (vertical direction) enters the side surfaces 22b of the light guide plate 22 and is directed to the Z-axis direction (the light output direction in the liquid crystal display module 11) as illustrated in FIG. 3. The light is output from the main plate surface 22a toward the diffuser plate 19a. Then, the light transmits through the diffuser plate 19a and the optical sheets 19b to be converted to substantially a planer light and irradiated to the liquid crystal panel 15.

The lighting of each LED 21b generates heat. The edge-light type backlight device 16 of the present embodiment is flat and the inner space is very small, and therefore the heat is less likely to be released to outside. In the present embodiment, the hole 26 is formed in the exterior members 13, 14 that house the liquid crystal display module 11. Therefore, external air flows into the space in the exterior members 13, 14 via the hole 26 and the air in the exterior members 13, 14 flows out to outside. This releases the heat from each LED 21b to outside. Additionally, the hole 26 is provided to overlap with the LEDs 21b in a direction along the display surface 15a. Also, the side plates 17b of the bezel 17 are provided to correspond to the holes 26 so as to be exposed to the external air, and the side plates 17b of the bezel 17 are thermally connected to the wiring boards 21a having the LEDs 21b thereon via the long-side side plates 18b of the chassis 18. Thus connected parts are made of metal having excellent heat conductivity such as an aluminum material. Therefore, the heat generated at each LED 21b is quite efficiently transferred to the external air introduced via the hole 26. This efficiently cools down each LED 21b. Further, each hole 26 opens in the vertical direction in the upper and lower side walls 13b, 14b. Therefore, the convection generated in the exterior members 13, 14 by the heat from each LED 21b efficiently circulates the air inside and outside of the device and accelerates the air out.

The hole 26 is formed in the exterior members 13, 14 of the liquid crystal display device 10 and the metal member (bezel 17) that has increased temperature due to the heat from each LED 21b is provided to correspond thereto. To ensure safety, the hole 26 should be designed to be narrow enough so that the user's finger is not inserted from the hole 26. Further, if a request for improving the function of prevention of finger insertion into the hole 26 is made, it is likely to be requested that the hole 26 should be designed in a more complicated shape.

If the hole is formed in only one of the exterior members and the opening edge is formed on the one of the exterior members, a mold for molding the exterior member with resin has a pin that has a shape corresponding to the shape of the opening edge of an endless loop. This restricts a design in the width size of the hole to ensure strength of the pin and also restricts a design in the complicated shape. It is also required to use a so-called slide-type mold that opens in a direction perpendicular to the assembling direction of the exterior members. This is likely to increase a cost.

A pin for molding the opening edge 27 is formed in the mold for molding each exterior member 13, 14 (the pin and the mold are not shown). In the present embodiment, the opening edge 27 of the hole 26 is shared by the both exterior members 13, 14 and the opening edge 27 of each exterior member 13, 14 is formed in a U-shape. Therefore, the pin is designed without any restriction in the width size or the shape of the hole 26. In the present embodiment, the design of the hole 26 in its width size and shape is freely determined and various designs are achieved with considering safety and heat releasing ability. The opening edge 27 is open in the assembling direction of the exterior members 13, 14. This enables to form the opening edge 27 with using a mold that opens in the assembling direction. This makes unnecessary to use the slide-type mold and enables manufacturing at a low cost.

To improve the heat-releasing efficiency, it is preferable to increase an opening area of the hole 26. Therefore, the hole 26 is formed in an elongated shape along the X-axis direction in the present embodiment. However, if one of the exterior members has the entire opening edge, one of the long-side opening edges is formed in abridge and the long-side opening edge of the bridge shape becomes in an thin elongated shape. This may cause problems in strength. Comparing to such a case, in the present embodiment, the opening edge 27 is formed in the both exterior members 13, 14. This prevents such a bridge-shaped part from being formed and sufficient strength of the opening edge 27 is ensured.

As explained above, the liquid crystal display device 10 according to the present embodiment includes the liquid crystal display module 11 and a pair of exterior member 13, 14. The liquid crystal module 11 includes the liquid crystal panel 15 that is configured to display images and LEDs 21b that are arranged on a surface that is perpendicular to the display surface 15a of the liquid crystal panel 15. The exterior members 13, 14 house the liquid crystal display module 11 therein. One of the exterior members 13, 14 is provided on the display surface 15a side of the liquid crystal display module 11 and the another one is provided on the side opposite from the display surface 15a side and the exterior members 13, 14 are connected to each other. The hole 26 is formed in the long-side side walls 13b, 14b among the side walls 13b, 13c, 14b, 14c that are connecting parts of the exterior members 13, 14. The hole 26 penetrates through the long-side side walls 13b, 14b. The opening edge 27 is shared by the exterior members 13, 14.

Accordingly, air flows in and out of the exterior members 13, 14 via the hole 26. This preferably releases heat generated at the LEDs 21b when they are lit on. The opening edge 27 of the hole 26 is shared by the exterior members 13, 14. Therefore, compared to a case that one of the exterior members 13, 14 has an entire opening edge, the hole 26 and the exterior members 13, 14 are freely designed.

The hole 26 and the LEDs 21b are provided so as to be overlapped with each other in a direction along the display surface 15a. Accordingly, the heat releasing property is improved compared to a case that the hole and LEDs are provided in an offset alignment.

The bezel 17 that forms the liquid crystal display module 11 and is made of metal is provided to correspond to the hole 26. Accordingly, the bezel 17 made of metal having good heat conductivity improves the heat releasing property.

The liquid crystal display module 11 includes the chassis 18 that is in contact with the bezel 17. The chassis 18 accommodates the LEDs 21b that are light sources and is made of metal. Since the chassis 18 accommodating the LEDs 21b therein is made of metal having good heat conductivity and comes in contact with the bezel 17, the heat generated at the LEDs 21b is released outside more efficiently.

The wiring board 21a having the LEDs 21b thereon is housed in the chassis 18 and it is in contact with the chassis 18. Since the wiring board 21a having the LEDs 21b thereon is in contact with the chassis 18, the heat generated at the LEDs 21b is efficiently released outside.

The wiring board 21a is made of metal. Since the wiring board 21a that comes in contact with the chassis 18 is made of metal having good heat conductivity, the heat generated at the LEDs 21b is released to outside more efficiently.

The LEDs 21b that are light sources are arranged on a surface of the wiring board 21a that is substantially perpendicular to the display surface 15a. Accordingly, heat generated at the LEDs 21b that are arranged on a surface of the wiring board 21a that is substantially perpendicular to the display surface 15a is released to outside efficiently.

The liquid crystal display module 11 includes the chassis 18 and the metal fixing members 25. The chassis 18 houses the LEDs 21b therein and the fixing members 25 fix the liquid crystal display module 11 and the front-side first exterior member 13 of a pair of exterior member 13, 14. The fixing members 25 are in contact with the portion of the chassis 18 on which the LEDs 21b are arranged. Accordingly, the heat generated at the LEDs 21b are transferred to the first exterior member 13 via the chassis 18 accommodating the LEDs 21b and the metal fixing members 25 having good heat conductivity. This achieves improved heat releasing property combined with the heat releasing from the hole 26.

The stand 12 is provided to support the liquid crystal display module 11 so that the display surface 15a lies along the vertical direction. The opening edge 27 is formed so that the hole 26 opens in the vertical direction. Accordingly, the heat releasing is accelerated by utilizing the air convection in the exterior members 13, 14 due to the heat generated at the LEDs 21b.

### Second Embodiment

A second embodiment of the present invention will be explained with reference to FIGS. 7 and 8. The shape of an hole 26-A is changed from the first embodiment. In the second embodiment, the configurations similar to the first embodiment are indicated by the same symbols with “-A” and the same operations and effects will not be explained.

The hole 26-A is formed in a zigzag as illustrated in FIGS. 7 and 8. Specifically, the hole 26-A is configured by connecting alternately a plurality of first holes 26a each of which extends in the X-axis direction and a plurality of second holes 26b each of which extends in the Z-axis direction. The connecting part is configured by ends of each first hole 26a and each second hole 26b. The first hole 26a and the second hole 26b intersect at substantially a right angle. A width (in the X-axis direction) of the first hole 26a is relatively greater than a width (in the Z-axis direction) of the second hole 26b. Since the hole 26-A is formed in a meandering shape, an opening area of the hole 26-A is greater than the hole 26 that is formed straight along the X-axis direction like the first embodiment (the difference in the opening areas corresponds to an opening area of the second holes 26b extending in the Z-axis direction).

A plurality of comb-like projections 28, 29 are formed at an opening edge 27-A of the hole 26-A. Specifically, each projection 28, 29 extends along the Z-axis direction from a surface (along the X-axis direction) of each recess 13d-A, 14d-A of a corresponding first exterior member 13-A and a second exterior member 14-A. A plurality of projections 28, 29 are formed at predetermined intervals therebetween along the X-axis direction. A projection size of each projection 28, 29 is greater than a depth (in the Z-axis direction) of each recess 13d-A, 14d-A of the exterior member 13-A, 14-A. Therefore, a distal end of each projection 28, 29 extends over the connection part BP of the exterior members 13-A, 14-A. In other words, each projection 28 of the first exterior member 13-A and each projection 29 of the second exterior member 14-A are overlapped with each other in their alignment direction (X-axis direction). Each projection 28 of the first exterior member 13-A and each projection 29 of the second exterior member 13-A are arranged alternately in the X-axis direction. Therefore, the projection 29 of the second exterior member 14-A is positioned between the adjacent projections 28 of the first exterior member 13-A and the projection 28 of the first exterior member 13-A is positioned between the adjacent projections 29 of the second exterior member 14-B. An interval between the projections 28 of the first exterior member 13-A is substantially equal to an interval between the projections 29 of the second exterior member 13-B. The interval between the projections 28 (29) corresponds to a total of the width (in the X-axis direction) of the projection 28 (29) and twice the width of the first hole 26a. Therefore, in the mold used for molding each of the exterior members 13-A, 14-A with resin, the pins for molding the recesses 13d-A, 14d-A and the projections 28, 29 (the pins and the mold are not shown) are formed in a comb-like shape corresponding to the projections 28, 29 and the thickness of each pin corresponds to the interval between the projections 28 (29). This improves strength of the mold.

As explained above, in the liquid crystal display device 10-A of the second embodiment, the opening edge 27-A is formed so that the hole 26-A is formed in a meandering shape. To prevent a finger from being inserted in the hole 26-A from outside, the opening width should be restricted to be a predetermined size or smaller, and this may restrict the opening area of the hole 26-A and heat releasing property. The hole 26-A that is formed in the meandering shape ensures a great opening area with restricting the opening width and achieves improved heat releasing property.

The projections 28, 29 that are formed in a comb-like shape are formed on the opening edge 27-A. Accordingly, the projections 28, 29 having a comb-like shape preferably restrict a finger from entering the hole 26-A from outside and improve outer appearance.

The projections 28, 29 are formed on the exterior members 13-A, 14-A respectively and the projections 28 formed on the first exterior member 13-A and the projections 29 formed on the second exterior member 14-A are provided alternately. This ensures an enough interval between the projections 28 of the first exterior member 13-A and an enough interval between the projections 29 of the second exterior member 14-A so that the exterior members 13-A, 14-A are easily manufactured.

### Third Embodiment

A third embodiment of the present invention will be explained with reference to FIGS. 9 to 11. In the third embodiment, a sealing member 30 for sealing a hole 26-B is provided. In the third embodiment, the configurations similar to the first embodiment are indicated by the same symbols with “-B” and the same operations and effects will not be explained.

A sealing member 30 is provided between the exterior members 13-B, 14-B and the liquid crystal display module 11-B so as to surround the hole 26-B, as illustrated in FIGS. 9 and 10. The sealing member 30 is made of a rubber material excellent in adhesion and formed in a frame slightly greater than the hole 26-B, that is, formed in an endless loop. The sealing member 30 is closely adhered to the inner surface of the opening edge 27-B of the hole 26-B in the exterior members 13-B, 14-B. The sealing member 30 is provided over an entire periphery of the hole 26-B. The sealing member 30 is also adhered to the outer surface of the long-side side plate 17b-B of the bezel 17-B that corresponds to the hole 26-B. Accordingly, if dust or any foreign obstacle may enter the hole 26-B from outside the liquid crystal display device 10B, the dust or foreign obstacle remains in a space defined by the sealing member 30. This prevents the dust or foreign obstacle from being dispersed widely in the space in the exterior members 13-B, 14-B.

The sealing member 30 is compressed in the Y-axis direction between the liquid crystal display module 11-B and each of the exterior members 13-B, 14-B and also compressed in the Z-axis direction. As illustrated in FIG. 11, the first exterior member 13-B and the second exterior member 14-B are assembled to the liquid crystal display module 11-B in the Z-axis direction from the front side (display surface 15a-B side) and the rear side (opposite from the display surface 15a-B side) to form the liquid crystal display device 10-B. In this process, the sealing member 30 is compressed in the Y-axis direction by the opening edge 27-B of the exterior members 13-B, 14-B and also compressed in the Z-axis direction that is an assembling direction of the exterior members 13-B, 14-B. Thus, the sealing member 30 is compressed in two directions that are perpendicular to each other, and this improves a degree of adhesion to the exterior members 13-B, 14-B and the liquid crystal display module 11-B and achieves high sealing ability.

As explained above, in the liquid crystal display device 10-B of the third embodiment, the sealing member 30 is provided between the exterior members 13-B, 14-B and the liquid crystal display module 11-B so as to surround the hole 26-B. Accordingly, a space between the exterior members 13-B, 14-B and the liquid crystal display module 11-B is sealed by the sealing member 30 that is provided to surround the hole 26-B. If dust may enter the hole 26-B from outside, the dust is prevented from being dispersed widely in the space in the exterior members 13-B, 14-B. The exterior members 13-B, 14-B are provided on the display surface 15a-B side and on the side opposite from the display surface 15a-B side with respect to the liquid crystal display module 11-B respectively. Therefore, the sealing member 30 is compressed in a direction along the display surface 15a-B and also compressed in a direction substantially perpendicular to the display surface 15a-B. This achieves high sealing ability.

The sealing member 30 is formed in an endless loop so as to surround an entire periphery of the hole 26-B. Accordingly, the sealing member 30 is formed by only one component and this reduces the number of parts and the number of assembling steps.

### Fourth Embodiment

A fourth embodiment of the present invention will be explained with reference to FIG. 12. In the fourth embodiment, the configuration of a portion of the liquid crystal display module 11-C that corresponds to the hole 26-C is changed. In the fourth embodiment, the configurations similar to the first embodiment are indicated by the same symbols with “-C” and the same operations and effects will not be explained.

The side plate 17b-C of the bezel 17-C of the present embodiment extends in the Z-axis direction shorter than the one of the first embodiment, as illustrated in FIG. 12. Therefore, only distal ends of the side plates 18b-C (including the short-side side plates that are not shown) of the chassis 18-C are fitted to the side plates 17b-C of the bezel 17-C. The long-side side plate 18b-C of the side plate 18b-C of the chassis 18-C is provided to correspond to the hole 26-C. Specifically, the side plate 17b-C of the bezel 17-C extends so as not to overlap with the LED unit 21-C and the hole 26-C in the Y-axis direction. Therefore, almost entire area of the portion of the long-side side plate 18b-C that is in contact with the wiring board 21a-C of the LED unit 21-C corresponds to the hole 26-C. The long-side side plate 18b-C is provided to correspond to the hole 26-C and exposed to the external air. The long-side side plate 18b-C is thermally connected to the wiring board 21a-C having the LEDs 21b-c thereon and thus connected parts are made of metal excellent in heat conductivity such as an aluminum material. Therefore, if heat is generated at the LEDs 21b-C of the LED unit 21-C that are lit, the heat from the LEDs 21b-C is efficiently transferred to the external air flowing through the hole 26-C. Compared to the first embodiment, since the bezel 17-C is not provided between the wiring board 21a-C and the hole 26-C, heat releasing efficiency is improved.

As explained above, according to the liquid crystal display device 10-C of the fourth embodiment, the liquid crystal display module 11-C includes the chassis 18-C that houses the LEDs 21b-C and the metal chassis 18-C of the liquid crystal display module 11-C is arranged to correspond to the hole 26-C. Accordingly, the chassis 18-C is provided to correspond to the hole 26-C as a metal member having good heat conductivity, and this achieves good heat releasing property.

The LEDs mounted on the wiring board 21a-C are housed in the chassis 18-C and the wiring board 21a-C is in contact with the chassis 18-C. Accordingly, the wiring board 21a-C having the LEDs 21b-C thereon that is in contact with the chassis 18-C efficiently releases heat generated at the LEDs 21b-C to outside.

The wiring board 21a-C is made of metal, and the wiring board 21a-C that comes in contact with the chassis 18-C is made of metal excellent in heat conductivity. This further efficiently releases heat generated at the LEDs 21b-C to outside.

The LEDs 21b-C that are the light sources are arranged on a surface of the wiring board 21a-C that is substantially perpendicular to the display surface 15a-C. This efficiently releases the heat generated at the LEDs 21b-C to outside. The LEDs are arranged on a surface of the wiring board 21a-C substantially perpendicular to the display surface 15a-C.

### Fifth Embodiment

A fifth embodiment of the present invention will be explained with reference to FIG. 13. In the fifth embodiment, a configuration of a portion of the liquid crystal display module 11-D that corresponds to the hole 26-D is further changed from the fourth embodiment. In the fifth embodiment, the configurations similar to the fourth embodiment are indicated by the same symbols with “-D” and the same operations and effects will not be explained.

Apertures 31 are formed in the long-side side plates 18b-D of the chassis 18-D so as to penetrate therethrough, as illustrated in FIG. 13. Three (a plurality of) apertures 31 are formed in each long-side side plate and communicate spaces inside and outside the chassis 18-D. The wiring board 21a-D of the LED unit 21-D is provided to correspond to the hole 26-D via the apertures 31. The wiring board 21a-D having the LEDs 21b-D thereon is provided to correspond to the hole 26-D, and this exposes the wiring board 21a-D to the external air. Further, the wiring board 21a-D is made of metal having excellent heat conductivity such as an aluminum material. Therefore, if heat is generated at the LEDs 21b-D of the LED unit 21 that are lit, the heat from the LEDs 21b-D is quite efficiently transferred to the external air flowing through the hole 26-D. Further, as compared to the fourth embodiment, the external air flowing through the hole 26-D directly draws heat from the wiring board 21a-D, and this further improves heat releasing efficiency.

As explained above, in the liquid crystal display device 10-D of the fifth embodiment, the liquid crystal display module 11-D includes the chassis 18-D that houses the LEDs 21b-D. The LEDs 21b-D are mounted on the wiring board 21a-D and housed in the chassis 18-D. The metal wiring board 21a-D of the liquid crystal display module 11-D is provided to correspond to the hole 26-D. The wiring board 21a-D having the LEDs 21b-D thereon is provided to correspond to the hole 26-D as a metal member having good heat conductivity. This achieves good heat releasing property.

The LEDs 21b-D that are the light sources are arranged on a surface of the wiring board 21a-D that is substantially perpendicular to the display surface 15a-D. This efficiently releases the heat generated at the LEDs 21b-D to outside. The LEDs are arranged on a surface of the wiring board 21a-D that is substantially perpendicular to the display surface 15a-D.

The wiring board 21a-D is provided to correspond to the hole 26-D via the apertures 31 formed in the chassis 18-D. Accordingly, if the chassis 18-D is positioned to overlap with the hole 26-D in a direction substantially perpendicular to the display surface 15a-D, the wiring board 21a-D is provided to correspond to the hole 26-D, and this improves heat releasing ability.

### Sixth Embodiment

A sixth embodiment of the present invention will be explained with reference to FIG. 14. In the sixth embodiment, the shape of the hole 26-E is changed from the second embodiment. In the sixth embodiment, the configurations similar to the second embodiment are indicated by the same symbols with “-E” and the same operations and effects will not be explained.

The hole 26-E is formed in a wavy meandering shape. The hole 26-E has substantially a constant width over an entire length. The opening area of the hole 26-E is greater than the hole 26 in the first embodiment that is formed in a straight shape along the X-axis direction. The difference in the opening areas is caused by the meandering. At the opening edge 27-E of the hole 26-E, projections 32, 33 and recesses 34, 35 are formed in adjacent to each other. Each projection 32, 33 is formed in an arc with a plan view. Specifically, at the opening edge 27-E of each exterior member 13-E, 14-E, the projections 32, 33 each having an arc-shaped top surface and the recesses 34, 35 each formed along the arc-shaped top surface of each projection 33, 32 respectively are provided alternately in the X-axis direction. The projection 33 of the second exterior member 14-E is provided between the adjacent projections 32 of the first exterior member 13-E, and the projection 32 of the first exterior member 13-E is provided between the adjacent projections 33 of the second exterior member 14-E. This relation is same in the recesses 34, 35. An arrangement interval between the projections 32 (recesses 34) of the first exterior member 13-E is substantially equal to an arrangement interval between the projections 33 (recesses 35).

### Seventh Embodiment

A seventh embodiment of the present invention will be explained with reference to FIG. 15. In the seventh embodiment, a configuration of the sealing member 30-F is changed from the third embodiment. In the seventh embodiment, the configurations similar to the third embodiment are indicated by the same symbols with “-F” and the same operations and effects will not be explained.

The sealing member 30-F is comprised of two parts including a first sealing member 36 and a second sealing member 37 as illustrated in FIG. 15. The first sealing member 36 is provided between the first exterior member 13-F and the liquid crystal display module 11-F. The second sealing member 37 is provided between the second exterior member 14-F and the liquid crystal display module 11-F. Each of the first sealing member 36 and the second sealing member 37 is formed in a loop with ends to partially surround the hole 26-F. Specifically, each of the first sealing member 36 and the second sealing member 37 includes a long-side part 36a, 37a along a long-side opening edge 27a-F and a short-side part 36b, 37b along a short-side opening edge 27b-F. Each of the first sealing member 36 and the second sealing member 37 is formed in a channel-like shape with plan view. The first sealing member 36 is adhered to the long-side opening edge 27a-F and the short-side opening edges 27b-F of the first exterior member 13-F, and the distal ends of the short-side parts 36b are adhered to the short-side opening edges 27b-F of the second exterior member 14-F. The second sealing member 37 is adhered to the long-side opening edge 27a-F of the second exterior member 14-F, and the short-side parts 37b is adhered to each outer side (a side opposite from the opening 26-F) of the short-side parts 36b of the first sealing member 36 and the distal ends of the short-side parts 27b are adhered to the first exterior member 13-F. The short-side parts 36b, 37b of the sealing members 36, 37 are overlapped with each other in the X-axis direction, that is a direction along the display surface (a direction perpendicular to the assembling direction of the exterior members 13-F, 14-F). This provides high sealing ability.

As explained above, in the liquid crystal display device 10-F of the seventh embodiment, the sealing member 30 is comprised of the first sealing member 36 and the second sealing member 37. The first sealing member 36 is provided between the first exterior member 13-F and the liquid crystal display module 11-F and the second sealing member 37 is provided between the second exterior member 14-F and the liquid crystal display module 11-F. Each end of the first sealing member 36 and the second sealing member 37 that partially surround the hole 26-F is connected to each other to form a loop, and the first and second sealing members 36, 37 are provided so that the distal ends are overlapped with each other in a direction along the display surface (X-axis direction). Accordingly, each of the first exterior member 13-F provided with the first sealing member 36 and the second exterior member 14-F provided with the second sealing member 14-F is used independently. This increases variation of assembling methods. The first sealing member 36 and the second sealing member 37 are provided so that their end parts are overlapped with each other, and this ensures sufficient sealing ability.

### Eighth Embodiment

An eighth embodiment of the present invention will be explained with reference to FIG. 16. In the eighth embodiment, the hole 26-G is divided into several parts. In the eighth embodiment, the configurations similar to the first embodiment are indicated by the same symbols with “-G” and the same operations and effects will not be explained.

The hole 26-G is divided into a plurality of divided holes 38 as illustrated in FIG. 16. The divided holes 38 are provided along the X-axis direction in the exterior members 13-G, 14-G. A defining part 39 is provided between the adjacent divided holes 38. The number of divided holes 38 may be changed arbitrarily according to a size of the liquid crystal display device 10-G.

### Other Modifications

The embodiments of the present invention have been described, however, the present invention is not limited to the above embodiments explained in the above description and the drawings. The following embodiments may be included in the technical scope of the present invention, for example.

(1) In the above embodiments, the recesses are formed in the first and second exterior members so that each one of the exterior members has the opening edge of the hole. However, the recess may be formed in only one of the exterior members.

(2) As an example of the modification (1), as illustrated in FIG. 17, a recess 13d′ is formed in only the first exterior member 13′. Accordingly, the first exterior member 13′ has one of the long-side opening edges 27a′ and two short-side opening edges 27b′, and the second exterior member 14′ has only another one of the long-side opening edges 27a′ of the hole 26′.

(3) As another example of the modification (1), as illustrated in FIG. 18, the recess 14d″ is formed in only the second exterior member 14″. Accordingly, the second exterior member 14″ has one of the long-side opening edges 27a″ and two short-side opening edges 27b″, and the first exterior member 13″ has only another one of the long-side opening edges 27a″ of the hole 26″.

(4) In the above embodiments, a depth of each recess of the exterior members is substantially equal, and the connection part of the exterior members is on a substantially same plane as the middle portion of the hole in its width direction. The depth of each recess of the exterior members may be different and the connection part of the exterior members may be offset from the middle portion of the hole in its width direction.

(5) In the above embodiments, the hole and the LED unit have substantially a same width and are arranged to correspond to each other along the Z-axis direction. However, the following is also included in the present invention. The width of the hole and the LED unit may be different from each other. The hole and the LED unit may be arranged to be slightly offset from each other with respect to the Z-axis direction (the assembling direction of the exterior members). The hole and the LED unit may be arranged so as not to be overlapped with each other in Y-axis direction (vertical direction).

(6) In the above embodiments, the LED unit is arranged on an upper end and a lower end of the liquid crystal display module in the vertical direction. The LED unit may be arranged on each end of the liquid crystal display module in the horizontal direction. In such a case, a hole that runs horizontally may be formed in each of the short-side side plates that are provided on two ends of the exterior members in the horizontal direction. Accordingly, the hole and the LED unit are arranged to be overlapped with each other in the horizontal direction.

(7) In the above embodiments, the hole and the LED unit are arranged to be overlapped with each other in a direction along the display surface. However, they may be arranged so as not to be overlapped with each other. Specifically, the LED unit may be provided on each of an upper end and a lower end of the liquid crystal display module in the vertical direction, and the hole may be provided in the short-side side walls of the exterior members to open in the horizontal direction. The LED unit may be provided on each of the ends of the liquid crystal display module in the horizontal direction, and the hole may be provided in the long-side side walls of the exterior members to open in the vertical direction.

(8) In the above embodiments, the wiring board of the LED unit is arranged on the liquid crystal display module so that the plate surface of the wiring board lies perpendicular to the display surface. However, the wiring board may be arranged so that the plate surface of the wiring board is slightly tilted from a surface perpendicular to the display surface.

(9) In the above embodiments, the substrate of the wiring board of the LED unit is made of metal. However, the substrate of the wiring board may be made of synthetic resin.

(10) In the above embodiments, the bezel, the chassis and the frame are made of metal. However, at least one of them may be made of synthetic resin, or all of them may be made of synthetic resin.

(11) In addition to the above embodiments, a shape or a size of the hole (opening edge) may be arbitrarily changed.

(12) In the above embodiments, the exterior members have side walls formed in substantially a rectangle tubular shape. However, only one of the exterior members may have the side walls and another one may have no side wall. In such a case, the hole maybe formed in a connecting part of the side wall of one exterior member and a portion of another one to which the side wall is connected.

(13) In the above embodiments, the distal ends of the side walls of the exterior members are in contact with and face each other. However, for example, one side wall may be fitted to another side wall and the side walls of the exterior members may be arranged to be overlapped with each other in a direction along the display surface.

(14) In the above embodiments, end surfaces (distal end surfaces) of the connecting part of the exterior members are substantially flat along the display surface. However, the end surfaces of the connecting part may be rough.

(15) In the above embodiments, the fixing member fixes the first exterior member and the liquid crystal display module. However, the fixing member may fix the second exterior member and the liquid crystal display module. In such a case, the first exterior member may be fixed to the chassis or the bezel so that the first exterior member is indirectly fixed to the second exterior member, or the first exterior member may be directly fixed to the second exterior member.

(16) In the above embodiments, as the supporting member that supports the liquid crystal display module, the stand that is placed on an installation surface such as a floor is provided. However, for example, a bracket may be provided as the support member. The bracket supports the liquid crystal display module on a vertically extending wall surface or a ceiling surface.

(17) In the above embodiments, the liquid crystal display module is arranged in a vertical position so that the short side is parallel to the vertical direction. However, the liquid crystal display module may be arranged in a vertical position so that the long side is parallel to the vertical direction.

(18) Another hole for releasing heat maybe formed in the exterior members in addition to the hole.

(19) In the above embodiments, the LEDs are used as the light source of the backlight device. However, a discharge tube (linear light source, tubular light source) such as a cold cathode tube or a hot cathode tube may be used as the light source.

(20) In the above embodiments, a TFT is used as the switching element of the liquid crystal display device. However, other switching element (for example, thin-film diode (TFD)) may be used, and the liquid crystal display device may be a color or a black-and-white display device.

(21) In the above embodiments, the liquid crystal display device includes the liquid crystal panel as a display element. However, any other display element may be used.

(22) The above embodiments provide the television receiver provided with the tuner. However, the display device may not include a tuner.

1. A display device comprising:
a display module including a display element and a light source, the display element being configured to display images and the light source being arranged on a surface that is substantially perpendicular to a display surface of the display element; and
a pair of exterior members housing the display module therein and one of which is provided close to the display surface and another one of which is provided away from the display surface, the exterior members being connected to each other and form a hole that runs all the way through the connected exterior members from inside to outside around the connecting area, the hole having an opening edge formed by edges of the exterior members.

2. The display device according to claim 1, wherein the hole and the light source are positioned so as to be overlapped with each other in a direction along the display surface.

3. The display device according to claim 1, wherein the display module further includes a metal member that is provided to correspond to the hole.

4. The display device according to claim 3, wherein:
the display module further includes a bezel that presses the display element from the display surface side; and
the bezel corresponds to the metal member.

5. The display device according to claim 4, wherein:
the display module further includes a chassis that is made of metal and houses the light source; and
the bezel is in contact with the chassis.

6. The display device according to claim 5, wherein the display module further includes a wiring board on which the light source is mounted is housed in the chassis so as to be in contact with the chassis.

7. The display device according to claim 6, wherein the wiring board is made of metal.

8. The display device according to claim 6, wherein the light source includes a plurality of light emitting diodes arranged on a surface of the wiring board substantially perpendicular to the display surface.

9. The display device according to claim 8, wherein:
the display module further includes a chassis that houses the light source; and
the chassis corresponds to the metal member.

10. The display device according to claim 9, wherein the display module further includes a wiring board on which the light source is mounted is housed in the chassis so as to be in contact with the chassis.

11. The display device according to claim 10, wherein the wiring board is made of metal.

12. The display device according to claim 10, wherein the light source includes a plurality of light emitting diodes arranged on a surface of the wiring board substantially perpendicular to the display surface.

13. The display device according to claim 12, wherein:
the display module further includes a chassis and a wiring board, the chassis houses the wiring board on which the light source is mounted; and
the wiring board corresponds to the metal member.

14. The display device according to claim 13, wherein the light source includes a plurality of light emitting diodes arranged on a surface of the wiring board substantially perpendicular to the display surface.

15. The display device according to claim 13, wherein:
the chassis has an aperture; and
the wiring board corresponds to the opening via the aperture.

16. The display device according to claim 1, further comprising a metal fixing member that fixes the display module to one of the exterior members, wherein:
the display module further includes a chassis that houses the light source therein; and
the fixing member is in contact with a portion of the chassis in which the light source is arranged.

17. The display device according to claim 1, further comprising a support member that supports the display module such that the display surface is positioned along a vertical direction, wherein the opening edge is formed such that the hole runs in the vertical direction.

18. The display device according to claim 1, wherein the opening edge is formed so as to form the hole in a meandering shape.

19. The display device according to claim 18, wherein each of the edges that form the opening edge has a plurality of projections to form a comb-like shape.

20. The display device according to claim 19, wherein the exterior members have the projections, and each projection formed in one of the exterior members and each projection formed in another one of the exterior members are arranged alternately.

21. The display device according to claim 1, further comprising a sealing member that is provided between the exterior members and the display module so as to surround the opening edge.

22. The display device according to claim 21, wherein the sealing member is formed in a closed loop so as to surround the entire opening edge.

23. The display device according to claim 21, wherein:
the sealing member includes a first sealing member and a second sealing member, the first sealing member being provided between one of the exterior members and the display module, the second sealing member being provided between another one of the exterior members and the display module; and
each of the first sealing member and the second sealing member is formed so as to partially surround the opening edge and arranged such that each end portion of the first sealing member and the second sealing member are overlapped with each other in a direction along the display surface, thereby the first sealing member and the second sealing member forming a loop.

24. The display device according to claim 1, wherein the display element is a liquid crystal panel including liquid crystals sealed between a pair of substrates.

25. A television receiver comprising the display device according to claim 24.
